(19) United States
(12) Patent Application Publication
(10) Pub. No.: US 2002/0195868 A1
(43) Pub. Date: Dec. 26, 2002

(54) Vehicle seat having baby fastening device

(76) Inventor: Yiou Tze Tsai, Chang Hua (TW)

Correspondence Address: Yiou Tze TSAI, 7F, No. 46, Pin Ho 10 Street, Chang Hua, 500, TW

(21) Appl. No.: 09/887,958

(22) Filed: Jun. 21, 2001

(51) Int. Cl. A47D 15/00; B60R 21/00; A47C 31/00

(52) U.S. Cl. 297/487

(57) ABSTRACT

A seat device includes a seat member having a seat back for supporting a user, one or more fastening belts for fastening the user in the seat member, and a retaining device for retaining the user, particularly the baby in the seat member. The retaining device includes a U-shaped structure pivotally secured to the seat member and movable to a horizontal position for retaining the user in the seat member. The retaining device may include two arms pivotally secured to the seat member, and a bar pivotally secured to one of the arms for forming the U-shape structure.

### BACKGROUND OF THE INVENTION

1. Field of the Invention

The present invention relates to a seat, and more particularly to a vehicle seat having a device for fastening the babies without additional baby chairs or baby seats or car seats or baby carriers.

2. Description of the Prior Art

Typical vehicle seats have no fastening devices for fastening the babies on the car seats or the vehicle seats. Accordingly, additional baby chairs or baby seats or car seats or baby carriers are further required to be secured onto the car seats in order to support the babies on the car seats. However, one fastening device is required to secure the baby carriers onto the car seats, and another fastening device is required to be provided to secure the baby on the baby carrier.

The present invention has arisen to mitigate and/or obviate the afore-described disadvantages of the conventional baby chairs or baby seats or car seats.

### SUMMARY OF THE INVENTION

The primary objective of the present invention is to provide a vehicle seat including a device for fastening the babies directly and easily without additional baby chairs or baby seats or car seats or baby carriers.

In accordance with one aspect of the invention, there is provided a seat device comprising a seat member including a seat body and a seat back extended upward from the seat body for supporting a user, fastening means for fastening the user in the seat member, and retaining means for retaining the user in the seat member.

The retaining means includes a U-shaped member pivotally secured to the seat member and movable to a horizontal position for retaining the user in the seat member. The U-shaped member includes a pair of arms pivotally secured to the seat member and movable to a horizontal position, a first of the arms includes a bar rotatable outward of the first arm for allowing the arms and the bar to form a U-shape structure and for retaining the user in the seat member.

The seat back includes at least one recess formed therein for receiving the arms. The bar includes at least one socket provided therein for latching or locking the latches of the fastening belts of the fastening means.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a vehicle seat in accordance with the present invention;

FIG. 2 is a perspective view illustrating the operation of the vehicle seat;

FIG. 3 is a perspective view illustrating the other embodiment of the vehicle seat;

FIG. 4 is a perspective view illustrating the operation of the vehicle seat as shown in FIG. 3; and

FIG. 5 is a perspective view illustrating another embodiment of the vehicle seat.

### DETAILED DESCRIPTION OF THE PREFERRED EMBODIMENT

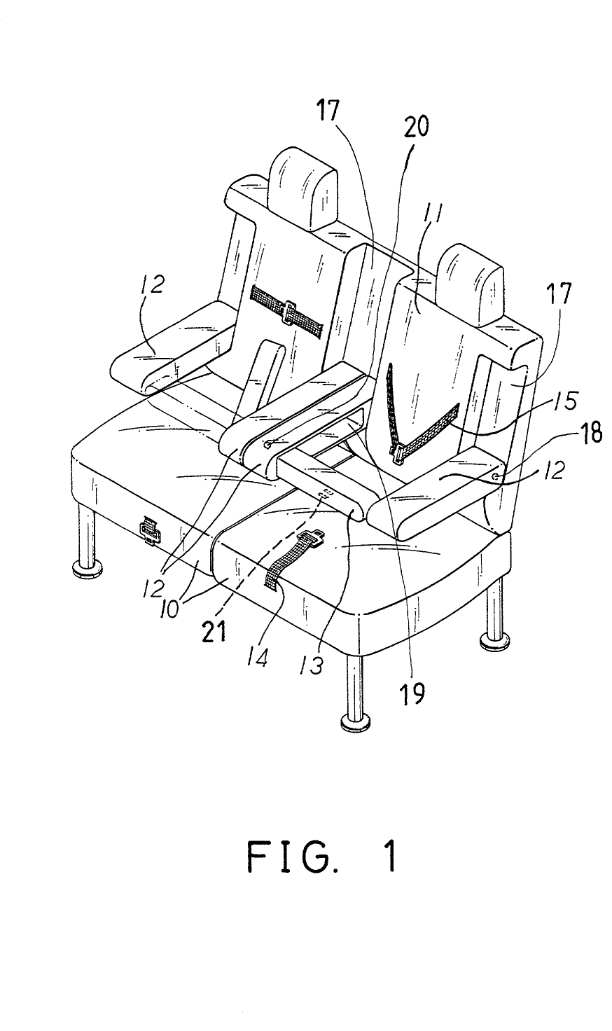

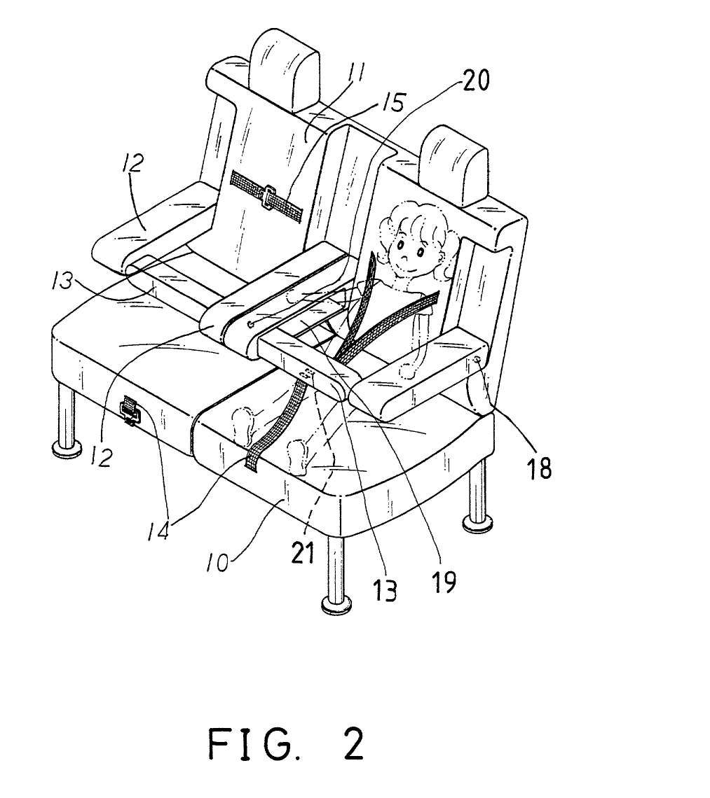

Referring to the drawings, and initially to FIGS. 1 and 2, a seat in accordance with the present invention, particularly a vehicle seat comprises a seat body 10, a seat back 11 provided on the rear portion and extended upward from the rear portion of the seat body 10. The vehicle normally includes two seat bodies 10 disposed or arranged side by side, and two seat backs 11 extended upward from the rear portions of the seat bodies 10 respectively. However, for illustrating purposes, a single vehicle seat is described hereinafter. The seat back 11 includes one or more recesses 17 formed therein.

A retaining device includes a pair of arms 12 rotatably secured to the seat back 11 with a pivot axle 18 and rotatable and receivable within the recesses 17 of the seat back 11. A first arm 12 includes a channel 19 formed therein and faced toward the other arm 12. A bar 13 has one end pivotally secured to the first arm 12 with a pivot pin 20 and rotatable relative to the arm 12 and receivable or foldable within the channel 19 of the arm 12, and movable outward of the channel 19 of the arm 12, such that the two arms 12 and the bar 13 may form a U-shaped retaining structure for stably retaining the baby within or in the vehicle seat. The bar 13 includes one or more sockets holes or sockets 21 provided therein.

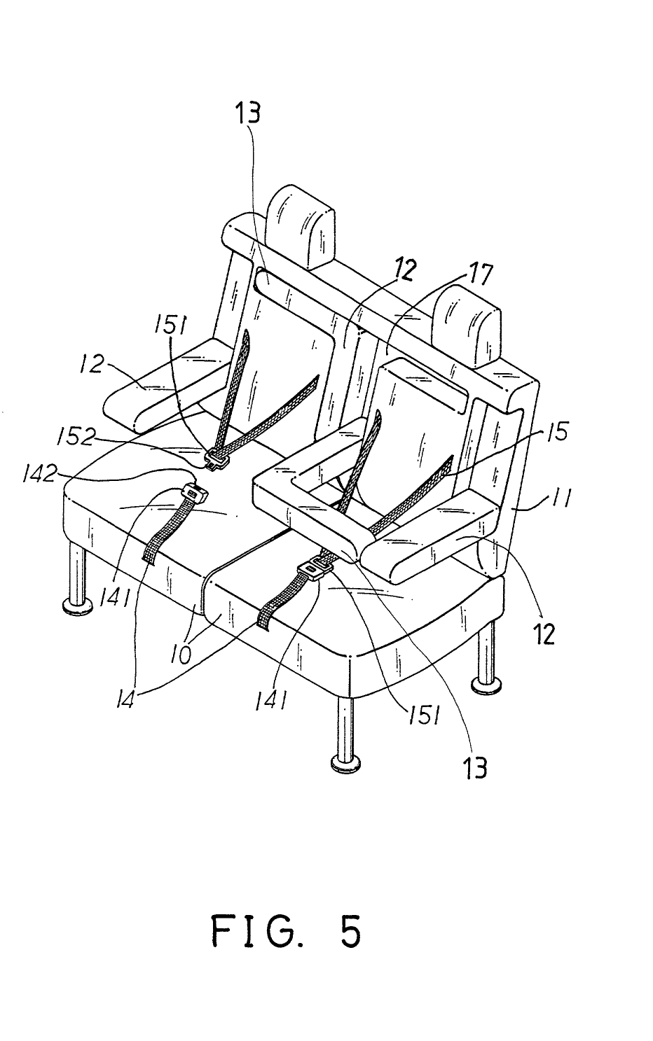

The seat body 10 and the seat back 11 each includes a typical fastening belt 14, 15 retractably received therein and may be pulled outward to engage with the sockets 21 of the bar 13 for retaining the baby in the vehicle seat. Alternatively, the fastening belts 14, 15 may each include a coupler 141, 151 secured thereto (FIG. 5). The coupler 151 includes a latch 152 for detachably locking into the socket hole 142 of the coupler 141, for retaining the baby on the vehicle seat. At this moment, the sockets 21 are not required to be provided or attached to the bar 13.

In operation, the retaining device including the arms 12 and the bar 13 may be rotated relative to the vehicle seat to a horizontal position for retaining the users, particularly the babies within the vehicle seat. The retaining device may also be folded and received in the recesses 17 of the seat back 11 in a folding configuration. The babies may thus be easily and quickly secured in the vehicle seat without additional baby chairs or baby carriers.

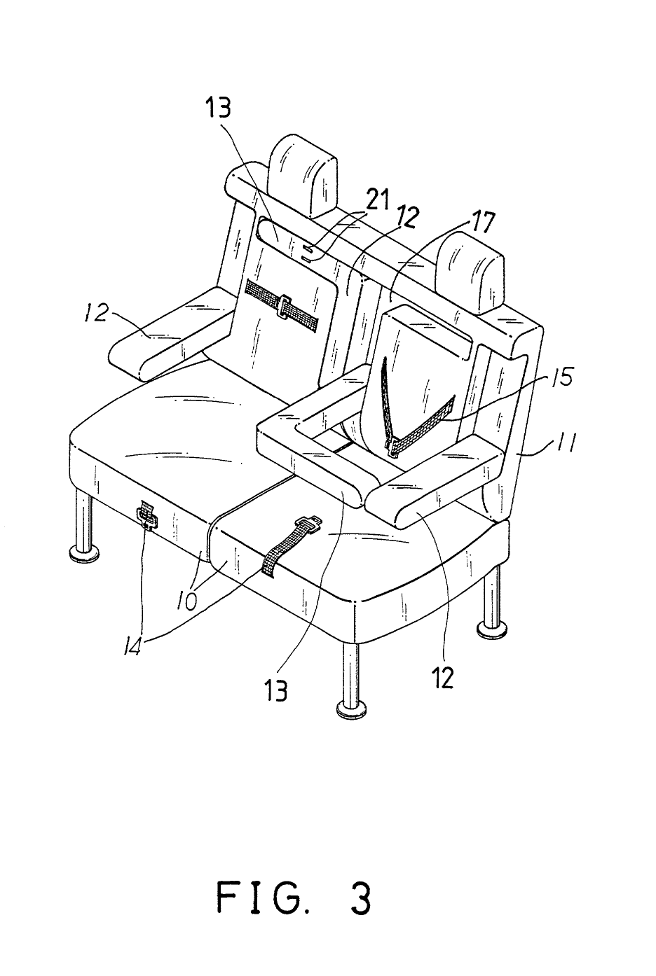

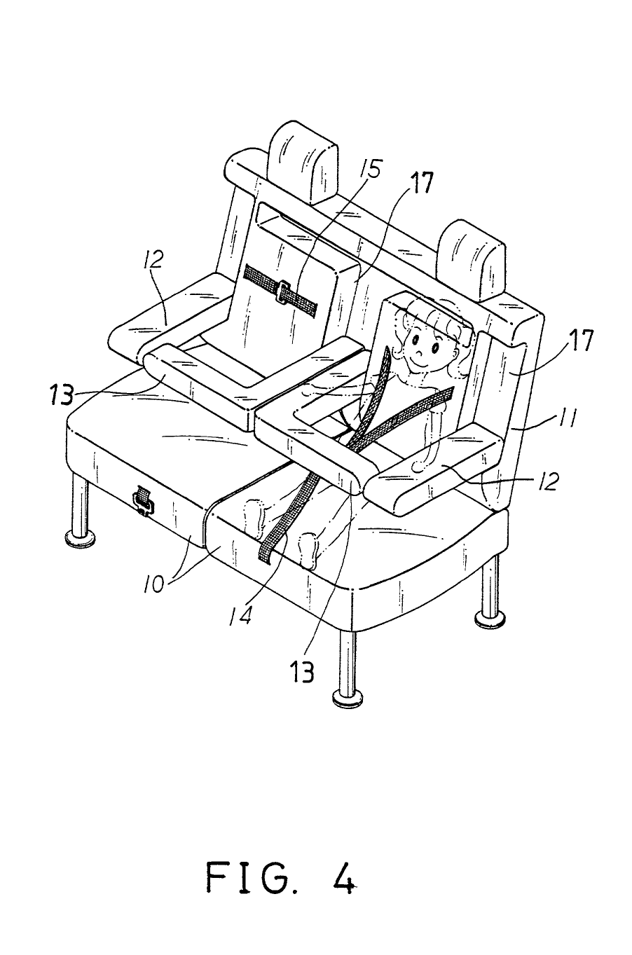

Alternatively, as shown in FIGS. 3 and 4, the bar 13 may be formed as an integral one-piece member having an L-shape. The recess 17 of the seat back 11 may include a corresponding L-shape for receiving the L-shape member 12, 13. Further alternatively, the arms 12 and the bar 13 may also be formed as an integral one-piece member having a U-shape and may be directly pivotally secured to the seat back 11. Still further alternatively, the arms 12 may be pivotally secured to the seat body 10 instead of to the seat back 11. The seat in accordance with the present invention may be used or attached to the vehicles, the trucks, the boats, the airplanes or the like.

Accordingly, the vehicle seat in accordance with the present invention includes a device for fastening the babies directly and easily without additional baby chairs or baby seats or car seats or baby carriers.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A seat device comprising:
a seat member including a seat body and a seat back extended upward from said seat body for supporting a user,
fastening means for fastening the user in said seat member, and
retaining means for retaining the user in said seat member.

2. The seat device according to claim 1, wherein said retaining means includes a U-shaped member pivotally secured to said seat member and movable to a horizontal position for retaining the user in said seat member.

3. The seat device according to claim 1, wherein said retaining means includes a pair of arms pivotally secured to said seat member and movable to a horizontal position, a first of said arms includes a bar pivotally secured thereto and rotatable outward of said first arm for allowing said arms and said bar to form a U-shape structure and for retaining the user in said seat member.

4. The seat device according to claim 3, wherein said seat back includes at least one recess formed therein for receiving said arms.

5. The seat device according to claim 3, wherein said bar includes at least one socket provided therein.
